(19) United States
(12) Patent Application Publication
(10) Pub. No.: US 2006/0036991 A1
(43) Pub. Date: Feb. 16, 2006

(54) Predictive help method, system and program product for software systems

(75) Inventors: Ana C. Biazetti, Cary, NC (US); Sean P. Logue, Morrisville, NC (US); Radhika Ramakrishnan, Cary, NC (US); Mary E. Sturgeon, Durham, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/916,651

(22) Filed: Aug. 12, 2004

(51) Int. Cl. G06F 9/44

(52) U.S. Cl. 717/104

(57) ABSTRACT

Under the present invention, a sequence of actions made by a user in operating a software system is tracked. Upon request by the user, predictive help is given based on the sequence of actions. In a typical embodiment, the predictive help is contained in a knowledge base, which is initially built during development of the software system. Specifically, the knowledge base is populated based on sequences of actions by other users as they operate the software system during its development. Moreover, the knowledge base can be updated after release of the software system as the user operates the system. To this extent, the knowledge base will “learn” the patterns of the user, and the predictive help will be continually tailored based thereon.

### BACKGROUND OF THE INVENTION

1. Field of the Invention

In general, the present invention provides a predictive help method, system and program product for software systems/programs. Specifically, the present invention allows predictive help to be provided to a user of a software program based on a sequence of actions performed by the user, as opposed to a single action or another static approach.

2. Related Art

As computer software becomes more sophisticated, computer users are increasingly in need of being provided help as they operate a program. Traditionally, help has been available in multiple forms such as documentation and computerized help shipped with the program, support information available through the World Wide Web, and reference manuals available through bookstores and similar outlets. Typically, users avoid these references unless they are absolutely needed. User dissatisfaction is frequently associated with the associated help resources even though the software program as a whole has failed because it has interrupted the users' workflow and prevented the users from achieving their goals. Ideally, the users should never be forced to interrupt their workflow.

To this extent, constant improvements in the field of providing user help are being made. Some typical help solutions include:
(1) A separate help window that is launched when the user selects an icon or the like in an interface. The user can then select a topic from a menu, table of contents, or index at which point associated content is shown in the window;
(2) Context-sensitive help that provides information in the form of a tool tip such as a label when a pointer device is placed over an interface object; and
(3) Interface help that contains tutorials showing the users how to perform certain operations in an interface.

Unfortunately, each of these methods is based on the users' learning of the software program rather than on the software program's learning of the user. That is, the methods described above all represent static approaches to providing help, as opposed to dynamic approaches. Moreover, these approaches at best consider a single action made by the users (e.g., placing a pointer device over an interface object). In actuality, the users are engaging in a sequence of actions to perform a desired task. None of the existing approaches considers the sequence of actions when providing help. Such a shortcoming not only reduces the ability to deliver accurate help to the users, but can also result in providing the users with too much information (e.g., presenting help topics that are not needed).

In view of the foregoing, there exists a need for a predictive help method, system and program product for software systems. Specifically, a need exists for a system in which a sequence of user actions in a software system is tracked. Further, a need exists for the system to provide predictive help to a user as needed (e.g., on-demand) based on the sequence of actions.

### SUMMARY OF THE INVENTION

In general, the present invention provides a predictive help method, system and program product for software systems. Specifically, under the present invention, a sequence of actions made by a user in operating a software system is tracked. Upon request by the user, predictive help is given based on the sequence of actions. In a typical embodiment, the predictive help is contained in a knowledge base, which is initially built during development of the software system. Specifically, the knowledge base is populated based on sequences of actions by other users as they operate the software system during its development. Moreover, the knowledge base can be updated after release of the software system as the user operates the system. To this extent, the knowledge base will “learn” the patterns of the user, and the predictive help will be continually tailored based thereon.

A first aspect of the present invention provides a predictive help method for software systems, comprising: tracking a sequence of actions performed by a user of a software system; receiving a request for help from the user with respect to one of the sequence of actions; and providing predictive help to the user in response to the request based on the sequence of actions.

A second aspect of the present invention provides a predictive help system for software systems, comprising: a task tracking system for tracking a sequence of actions performed by a user of a software system; a request reception system for receiving a request for help from the user with respect to one of the sequence of actions; and a predictive help system for providing predictive help to the user in response to the request based on the sequence of actions.

A third aspect of the present invention provides a predictive help program product for software systems stored on a recordable medium, which when executed, comprises: program code for tracking a sequence of actions performed by a user of a software system; program code for receiving a request for help from the user with respect to one of the sequence of actions; and program code for providing predictive help to the user in response to the request based on the sequence of actions.

A fourth aspect of the present invention provides a system for deploying a predictive help application for software systems, comprising: a computer infrastructure being operable to: track a sequence of actions performed by a user of a software system; receive a request for help from the user with respect to one of the sequence of actions; and provide predictive help to the user in response to the request based on the sequence of actions.

A fifth aspect of the present invention provides computer software embodied in a propagated signal for providing predictive help for software systems, the computer software comprising instruction to cause a computer system to perform the following functions: track a sequence of actions performed by a user of a software system; receive a request for help from the user with respect to one of the sequence of actions; and provide predictive help to the user in response to the request based on the sequence of actions.

Therefore, the present invention provides a predictive help method, system and program product for software systems.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a predictive help system for software systems according to the present invention.

FIG. 2 depicts an illustrative interface for a software system according to the present invention.

FIG. 3 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

As indicated above, the present invention provides a predictive help method, system and program product for software systems. Specifically, under the present invention, a sequence of actions made by a user in operating a software system is tracked. Upon request by the user, predictive help is given based on the sequence of actions. In a typical embodiment, the predictive help is contained in a knowledge base, which is initially built during development of the software system. Specifically, the knowledge base is populated based on sequences of actions by other users as they operate the software system during its development. Moreover, the knowledge base can be updated after release of the software system as the user operates the system. To this extent, the knowledge base will “learn” the patterns of the user, and the predictive help will be continually tailored based thereon.

As used herein, the term “software system” is intended to mean any software program or collection of software programs. Examples of software systems include, among others, word processing programs, web browsers, spreadsheet programs, operating systems, consumer financial software packages, computer programming systems, etc. Moreover, the term “action” is intended to mean any operation or the like performed by a user of a software system. Still yet, the term “task” is intended to mean a sequence of actions performed by a user to accomplish a goal.

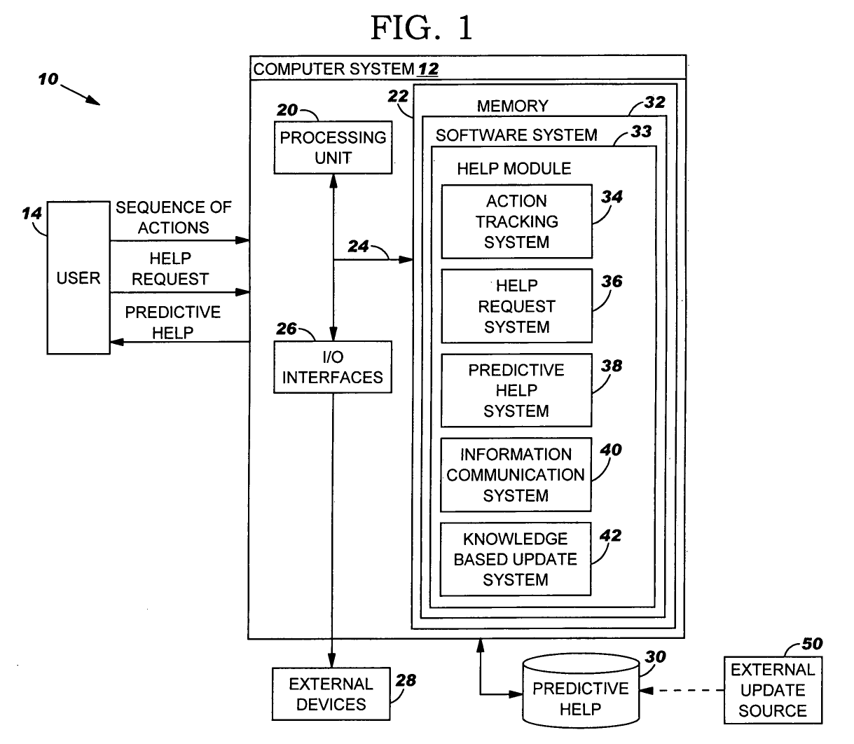

Referring now to FIG. 1, a system 10 according to the present invention is shown. In general, system 10 allows a user 14 operating a software system 32 on computer system 12 to be provided with predictive help based on a sequence of actions made by him/her. To this extent, computer system 12 is intended to represent any type of computerized device such as a desktop computer, a laptop computer, a workstation, a hand held device, a server, a client, etc. Moreover, it should be appreciated that the teachings of the present invention could be implemented on a stand-alone computer system 12 as shown, or over a network. For example, computer system 12 could be a server that user 14 interacts with via a client (not shown) over a network such as the Internet, a local area network (LAN), a wide area network (WAN), a virtual private network (VPN), etc. In such a case, a direct hardwired connection (e.g., serial port), or an addressable connection with computer system 12 could be implemented. The addressable connection may utilize any combination of wireline and/or wireless transmission methods. Moreover, conventional network connectivity, such as Token Ring, Ethernet, WiFi or other conventional communications standards could be used. Still yet, connectivity could be provided by conventional IP-based protocol.

As also depicted, computer system 12 generally comprises processing unit 20, memory 22, bus 24, input/output (I/O) interfaces 26, external devices/resources 28 and knowledge base 30. Processing unit 20 may comprise a single processing unit, or be distributed across one or more processing units in one or more locations, e.g., on a client and server. Memory 22 may comprise any known type of data storage and/or transmission media, including magnetic media, optical media, random access memory (RAM), read-only memory (ROM), a data cache, a data object, etc. Moreover, similar to processing unit 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LED screen, hand-held device, keyboard, mouse, voice recognition system, speech output system, printer, monitor/display, facsimile, pager, etc. Bus 24 provides a communication link between each of the components in computer system 12 and likewise may comprise any known type of transmission link, including electrical, optical, wireless, etc.

Knowledge base 30 can be any system (e.g., a database, file system, etc.) capable of providing storage for information under the present invention. Such information could include, among other things, associations of predictive help with sequences of actions. As such, knowledge base 30 could include one or more storage devices, such as a magnetic disk drive or an optical disk drive. In another embodiment, knowledge base 30 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 22 of computer system 12 is software system 32. Assume in an illustrative example that software system 32 is a consumer financial software package that allows user 14 to reconcile his/her banking accounts, pay bills, etc. As is typically the case with many software systems, user help is often available in the event a user needs assistance in performing one or more tasks (e.g., if user 14 is attempting to mark a check as reconciled). The traditional approach has been for the user to select a help icon or the like to access the help function of the software system. As indicated above, however, the existing help approaches are all static and/or rely on the user's learning of the software system. For example, many existing software systems would provide user 14 with a help index or the like that could be searched for an appropriate topic. In contrast, under the present invention, software system 32 is provided with a help module 33 that is dynamic and provides help based on an acquired/learned knowledge of user 14 as he/she operates software system 32.

As depicted, help module 33 includes action tracking system 34, help request system 36, predictive help system 38, information communication system 40 and knowledge base update system 42. Contained within knowledge base 30 is predictive help as associated with sequences of actions of other users. In a typical embodiment, knowledge base 30 is built during the design and development phase of software system 32, and can be updated from an external source 50 or the like. For example, as users operate software system 32 during its development, their sequences of activities and various help needs will be tracked. Later, if the same or similar sequences of actions are made, and help is requested, the help can be given based on the previous users' previous needs and selections. Thus, the help given to the current user will be “predictive” of his/her needs. For example, if user “A” performed actions “1, 2 and 3” (hereinafter the “sequence”) one or more times, and during the sequence requested help for a particular action, the same help could be presented to user “B” if he/she later performs the same or a similar sequence and requests help again. This would prevent user “B” from navigating about the help function of software system 32. To this extent, knowledge base 30 can include a list, table or the like that associates sequences of user actions with corresponding predictive help. The predictive help could be a single piece help topic, or a list of help topics. Shown below is an illustrative table depicting the association of sequences of actions with help topics:

| SEQUENCE OF ACTIONS | HELP TOPICS |
|---|---|
| Actions: A, B, Q | Topics: 1, 5 |
| Actions: E, P, G, D | Topics: 4, 8, 3 |
| Actions: X, Z, G, T, Q, M | Topics: 8, 2, 7 |
| Actions: R, T, D, V | Topics: 10, 3, 4, 6 |

When any of these sequences of actions are performed by a user, the corresponding help topics will be presented. It should be understood that the above table is intended to be illustrative. To this extent, it should be realized that any such table could have any quantity of entries. Moreover, as will be further described below knowledge base 30 could have multiple such tables depending on the identity of the user. It should also be appreciated that the manner in which knowledge base 30 is built is not intended to be limiting. For example, knowledge base 30 could be built using a systematic design approach in which the most common user actions are identified.

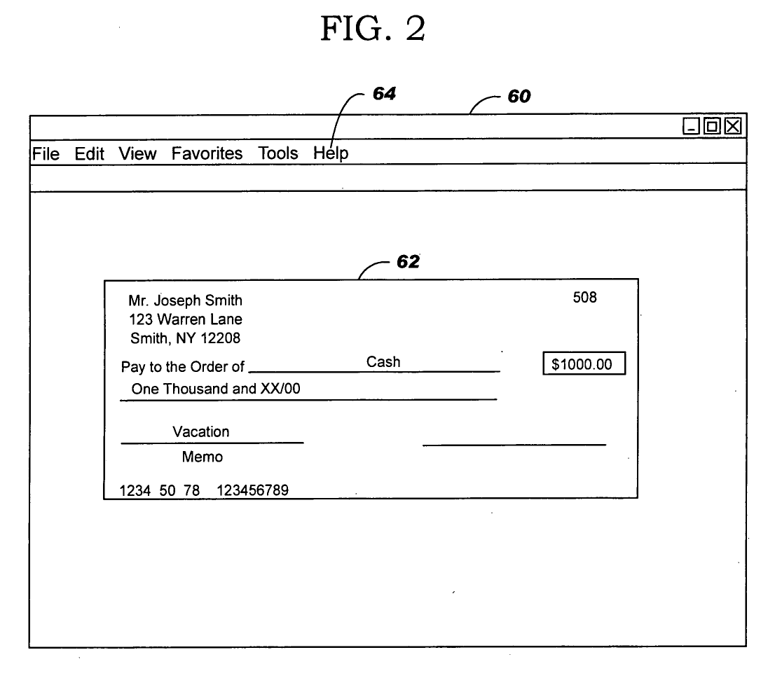

In any event, an initial knowledge base of predictive help is typically delivered concurrently with software system 32. This will provide user 14 with an initial base of predictive help that he/she could be presented should the needs arise. To this extent, assume as an illustrative example that user 14 is attempting to mark a check as reconciled in software system 32. Referring to FIG. 2, an illustrative interface 60 depicting a check 62 is shown. Further assume that in attempting to reconcile check 62, user 14 performs the following actions:
1. Go to the home page.
2. Click Favorite Accounts->Checking.
3. Scroll to desired check.
4. Select check and click the edit menu icon.
5. User 14 cannot find “reconcile,” so user 14 double-clicks the check which opens the check in edit mode.
6. User 14 still cannot find “reconcile,” so user 14 clicks the “Cancel” button to exit the edit mode.
   As user 14 performs this sequence of actions using interface 60, action tracking system 34 (FIG. 1) will track/record each action. Now assume that user 14 gives up and selects a “Help” button 64 in interface 60. Under previous systems, this would merely enter user 14 into a general help mode, which would likely present user 14 with a table of contents, an index, etc., which must then be searched and/or navigated about by user 14. As indicated above, this approach can be extremely frustrating to user 14 because the user 14 would have “drill down” through the help system to find the answer for which he/she is looking.

Referring back to FIG. 1, under the present invention, user 14's request for help would be received by help request system 36. Once received, predictive help system 38 would access knowledge base 30 and identify predictive help based on the sequence of actions performed by user 14. For example, assume that knowledge base 30 includes the same or a similar sequence of actions that is associated with the following help topics:
1. How to reconcile an individual check.
2. How to delete an individual check.
3. How to void an individual check.
   (As can be seen, the first help topic in this list is exactly what user 14 is attempting to accomplish.) This predictive help would be retrieved from knowledge base 30, and then presented to user 14 in any known manner (e.g., in an interface, pop-up window, etc.) by information communication system 40. User 14 can then select the topic he/she desired and obtain the needed help via information communication system 40. As can be seen, the methodology of the present invention not only provides tailored help to user 14, but also allows user 14 to be far more efficient and suffer less interruption to his/her workflow. Also, because the predictive help is based on a sequence of actions as opposed to a single action, it is more likely to address the point with which help is needed.

As indicated above, knowledge base 30 can be periodically updated from external source 50. However, it can also be updated specifically for user 14 via knowledge base update system 42. This allows help module 33 to actually learn the behavior of specific users. For example, assume that in a later session with software system 32, user 14 performed the same or a similar sequence of actions in another attempt to reconcile a check. Further assume that user 14 once again needed help. In this case, the predictive help that is presented to user 14 might only include the help topic user 14 previously selected (i.e., how to reconcile a check). This would make the system even more efficient. It should be appreciated, however, that knowledge base update system 42 could be programmed with a certain threshold before it will update knowledge base 30 for specific users. For example, user 14 might be required to perform the same or a similar sequence of actions, request help and select a certain help topic multiple times (e.g., three times) before the knowledge base is actually updated for user 14.

Regardless, when knowledge base 30 is updated to accommodate an individual user's behavior, different sets/tables of predictive help could be maintained. For example, predictive help set “A” could be a generic set of predictive help for new users; predictive help set “B” could be for user or group “B,” predictive help set “C” could be for user or group “C,” etc.

It should be appreciated that the predictive help provided to user 14 can be dynamic apart from tracking actions. That is, the predictive help presented to user 14 could be modified/tailored based on user 14's actions. For example, user 14 could be presented with help that is filled in with specific values he/she previously entered. This could be especially useful, for example in an IT monitoring environment, whereby predictive help could be presented including hardware and/or network identification values previously entered by user 14. Moreover, it should be understood that action tracking under the present invention is not limited to user 14's actions within a single software program. For example, when user 14 is operating multiple applications such as in a portal environment, predictive help can be presented based on user 14's actions across the multiple applications.

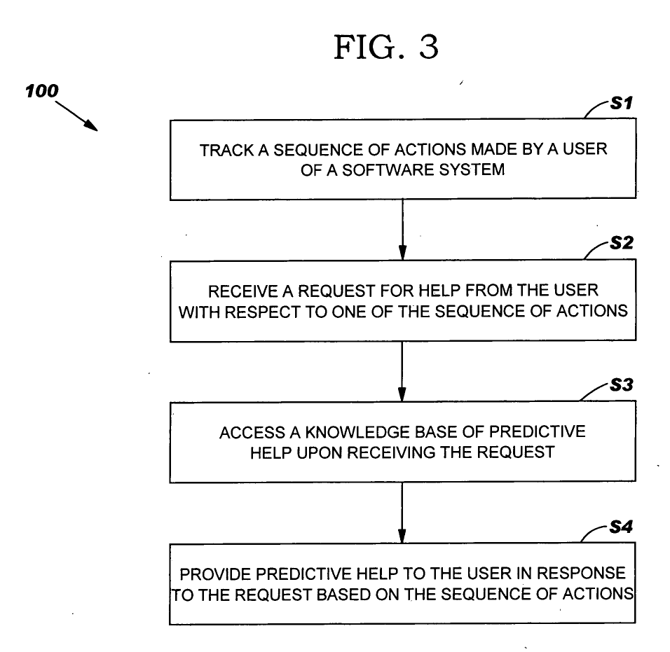

Referring now to FIG. 3, a method flow diagram 100 according to the present invention is shown. As depicted, first step S1 is to track a sequence of actions performed by a user of a software system. Second step S2 is to receive a request for help from the user with respect to one of the sequence of actions. Third step S3 is to access a knowledge base of predictive help upon receiving the request. Fourth step S4 is to provide predictive help to the user in response to the request based on the sequence of actions.

It should be appreciated that the teachings of the present invention could be offered as a business method on a subscription or fee basis. For example, software system 32, help module 33 and/or computer system 12 could be created, maintained, supported and/or deployed by a service provider that offers the functions described herein for customers.

It should also be understood that the present invention can be realized in hardware, software, a propagated signal, or any combination thereof. Any kind of computer/server system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the depiction of help module 33 of FIG. 1 is intended to be illustrative only. As such, the functionality cited herein could be carried out by a different configuration of systems (e.g., the function of one or more systems of help module 33 could be combined).

We claim:

1. A predictive help method for software systems, comprising:
tracking a sequence of actions performed by a user of a software system;
receiving a request for help from the user with respect to one of the sequence of actions; and
providing predictive help to the user in response to the request based on the sequence of actions.

2. The predictive help method of claim 1, wherein the providing step comprises accessing a knowledge base of predictive help upon receipt of the request.

3. The predictive help method of claim 2, further comprising populating the knowledge base prior to the tracking step, wherein the knowledge base is populated based on sequences of actions performed by other users of the software system.

4. The method of claim 2, further comprising updating the knowledge base based on the sequence of actions made by the user and a selection made by the user with respect to the predictive help.

5. The predictive help method of claim 1, wherein the request for help is received pursuant to a selection of a help icon within the software system by the user.

6. The predictive help method of claim 1, wherein the predictive help comprises a set of possible solutions to address the request.

7. The predictive help method of claim 1, further comprising:
receiving a selection made by the user with respect to the predictive help; and
providing information to the user corresponding to the selection.

8. A predictive help system for software systems, comprising:
a task tracking system for tracking a sequence of actions performed by a user of a software system;
a request reception system for receiving a request for help from the user with respect to one of the sequence of actions; and
a predictive help system for providing predictive help to the user in response to the request based on the sequence of actions.

9. The predictive help system of claim 8, wherein the predictive help system accesses a knowledge base of predictive help upon receipt of the request.

10. The predictive help system of claim 9, wherein the knowledge base is populated based on sequences of actions performed by other users of the software system.

11. The predictive help system of claim 9, further comprising a knowledge base update system for updating the knowledge base based on the sequence of actions made by the user and a selection made by the user with respect to the predictive help.

12. The predictive help system of claim 8, wherein the request for help is received pursuant to a selection of a help icon within the software system by the user.

13. The predictive help system of claim 8, wherein the predictive help comprises a set of possible solutions to address the request.

14. The predictive help system of claim 8, further comprising an information communication system for receiving a selection made by the user with respect to the predictive help, and for providing information to the user corresponding to the selection.

15. A predictive help program product for software systems stored on a recordable medium, which when executed, comprises:
program code for tracking a sequence of actions performed by a user of a software system;
program code for receiving a request for help from the user with respect to one of the sequence of actions; and
program code for providing predictive help to the user in response to the request based on the sequence of actions.

16. The predictive help program product of claim 15, wherein the program code for providing predictive help accesses a knowledge base of predictive help upon receipt of the request.

17. The predictive help program product of claim 16, wherein the knowledge base is populated based on sequences of actions performed by other users of the software system.

18. The predictive help program product of claim 16, further comprising program code for updating the knowledge base based on the sequence of actions made by the user and a selection made by the user with respect to the predictive help.

19. The predictive help program product of claim 15, wherein the request for help is received pursuant to a selection of a help icon within the software system by the user.

20. The predictive help program product of claim 15, wherein the predictive help comprises a set of possible solutions to address the request.

21. The predictive help program product of claim 15, further comprising program code for receiving a selection made by the user with respect to the predictive help, and for providing information to the user corresponding to the selection.

22. A system for deploying a predictive help application for software systems, comprising:
a computer infrastructure being operable to:
track a sequence of actions performed by a user of a software system;
receive a request for help from the user with respect to one of the sequence of actions; and
provide predictive help to the user in response to the request based on the sequence of actions.

23. Computer software embodied in a propagated signal for providing predictive help for software systems, the computer software comprising instruction to cause a computer system to perform the following functions:
track a sequence of actions performed by a user of a software system;
receive a request for help from the user with respect to one of the sequence of actions; and
provide predictive help to the user in response to the request based on the sequence of actions.
